(19) United States
(12) Patent Application Publication
(10) Pub. No.: US 2006/0206391 A1
(43) Pub. Date: Sep. 14, 2006

(54) Method and system for using cascading style sheets(CSS) to customize an online store

(76) Inventors: Donn Delson, Agoura Hills, CA (US); David Ron, Camarillo, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/349,684

(22) Filed: Feb. 8, 2006

Related U.S. Application Data
(63) Continuation-in-part of application No. PCT/US04/33950, filed on Oct. 14, 2004.
(60) Provisional application No. 60/511,289, filed on Oct. 14, 2003.

(51) Int. Cl. G06Q 30/00

(52) U.S. Cl. 705/26

(57) ABSTRACT

The present invention is directed to a system and method for using cascading style sheets to theme and customize a store whose actual generation and control flow is on a central server. The system provides for a server operator to host a store web page that links to a seller's website. The themes and appearance of the pages on the store web page are selected by the seller. Once selected, the themes are hyperlinked to the seller's site, enabling the seller to offer for sale the sale operator's products. The method contemplated provides for increased sales due to artificial competition between sellers for the server operator, statistical analyses detail which marketing initiatives are most effective, as well as increasing product distribution by offering the same product for sale from the same website while appearing to be a second, alternative website.

### CROSS-REFERENCE TO RELATED APPLICATIONS

This application is a Continuation-in-part of PCT Application No. PCT/US2004/033950, filed on Oct. 14, 2004, which claims priority of U.S. Provisional Application No. 60/511,289 filed on Oct. 14, 2003.

### BACKGROUND OF THE INVENTION

The present invention pertains generally to computer network based retail establishments and, more particularly, to a method and system of using cascading style sheets to dynamically modify, add and remove content without seller interaction.

The use of computer based sales is well-known to most businesses around the country, with some companies entirely based upon their Internet sales. Thus web pages, particularly those types of pages convenient and appealing to consumers are desired by the majority of commercial enterprises. However, for the commercial enterprise which manufactures only one type of product line, the likelihood of attracting a consumer to their website is limited to those consumers specifically looking for the manufacturer's product line.

For a real world example, as opposed to an electronic world, example, large department stores offer consignment goods for sale to consumers shopping in its stores. The small boutique manufacturer of the goods has its own stores selling its goods, but realizes an increase in sales as a result of the goods sold on consignment to the department store. In a similar manner, the small manufacturer of specialized computer hardware has its own web site, but may realize greater sales if its hardware were sold on a site that also offered other computer related accessories.

Furthermore, the design and layout of a web page may cause a commercial enterprise to incur appreciable costs. The maintenance and constant updating of a web page requires the attention of a support staff, as well as additional designers. Stale, or stagnant, web pages may cause consumers to lose interest in a particular commercial enterprise's products, resulting in reduced revenues.

Thus, there exists a need for a method and system that provides a commercial enterprise with the ability to sell its goods or services online, without having to expend additional sums to update, modify, add or remove content.

### SUMMARY OF THE PRESENT INVENTION

The present invention provides for a system and method for using cascading style sheets to theme and customize a store whose actual generation and control flow is on a central server.

In accordance with the present invention, there is provided a method for a seller to use a server operator's web site to sell its products. The seller subscribes to the web site hosted by the server operator. The seller then selects the appropriate appearance of the web page by using either a template or creating its own particular Cascading Style Sheet. The HTML of the seller's own web site is then linked to the Cascading Style Sheet selected and displayed on the server operator's web page. A user visits the server operator's web page and sees the seller's products on the Cascading Style Sheet background. The user may then purchase the product appearing on the server operator's web page. The order made by the user is tracked by the server operator and credited to the seller.

Further in accordance with the present invention, there is provided a system for using cascading style sheets to enable a seller to sell products and services through a server operator's web page. The system comprises a server maintained by the server operator, a database containing multiple templates and background cascading style sheets, and a seller's web page in HTML format.

Still further in accordance with the present invention, there is provided a system and method for using cascading style sheets to theme and customize a store whose actual generation and control flow is on a central server. The system provides for a server operator to host a store web page that links to a seller's website. The themes and appearance of the pages on the store web page are selected by the seller. Once selected, the themes are hyperlinked to the seller's site, enabling the server operator to offer for sale seller's products, while only storing the themes without the HTML of the seller's website. The method contemplated provides for increased sales due to artificial competition between sellers for the server operator, statistical analyses detailing which marketing initiatives are most effective, as well as increasing product distribution by offering the same product for sale from the same website while appearing to be a second, alternative website.

Further, in accordance with the present invention, there is provided a system for facilitating network-based commerce. The system includes template means adapted to generate electronic document data representing a plurality of preselected document display templates and means adapted for communicating selection data associated with the electronic document data to an associated operator. The system also includes means adapted for receiving from the associated operator customization data, which customization data includes data representing at least one of selected margins, positioning, color, and size, and wherein the customization data includes at least one of product data and service data, wherein the product data represents products available for sale and wherein the service data represents available services for sale. The system also comprises means adapted for generating, from the electronic document data and the customization data, customized electronic document data representing a customized user interface, and server means adapted for storing the customized electronic document data. In addition, the system also includes means adapted for communicating the customized electronic document data to an associated customer in accordance with a received customer query, and means adapted for receiving, from the associated customer, data representing at least one of the products and the services.

Still further, in accordance with the present invention, there is provided a method for facilitating network-based commerce. The method begins by generating electronic document data representing a plurality of preselected document display templates. Selection data, associated with the electronic document data, is then communicated to an associated operator. Customization data is then received from the associated operator, which includes data representing selected margins, positioning, color, and/or size, and wherein the customization data includes at least one of product data and service data, wherein the product data represents products available for sale and wherein the service data represents available services for sale. Customized electronic document data representing a customized user interface is then generated from the electronic document data and the customization data. The customized electronic document data is then stored on a server and communicated to an associated customer according to a received customer query. Data representing the products and/or services is then received from the associated customer.

Additional objects, advantages and novel features of the invention will be set forth in part in the description which follows, and in part will become apparent to those skilled in the art upon examination of the following or may be learned by practice of the invention. The objects and advantages of the invention may be realized and attained by various structures and methods as covered by the patent claims.

### BRIEF DESCRIPTION OF THE DRAWINGS

The accompanying figures incorporated in and forming a part of the specification, illustrates several aspects of the present invention, and together with the description serve to explain the principles of the invention. In the figures:

FIG. 1 is a block diagram illustrative of the system of the present invention; and

FIG. 2 is a representative diagram of process envisioned by operation of the system of the present invention.

### DETAILED DESCRIPTION OF PREFERRED AND ALTERNATE EMBODIMENTS

The present invention is directed to a system and method for a server operator to dynamically modify, add and remove content without the interaction of a seller. More particularly, the present invention allows for the use of Cascading Style Sheets to theme and customize a store whose actual generation and control flow is on a central server. The system allows a Server Operator to dynamically modify, add and remove content without Seller interaction. Initially, the Seller creates or selects from ready-made style templates to theme the site. The Seller then links to this new dynamic page from the Seller's original web site. Users can then buy products and services from Server Operator's site through the Seller's theme site. The orders are tracked by the Server Operator and credit is given to the Seller. The Site Operator keeps statistical analyses about purchases for the Seller's marketing utility. Further, the Server Operator gives Seller incentives to promote store sales on the theme site.

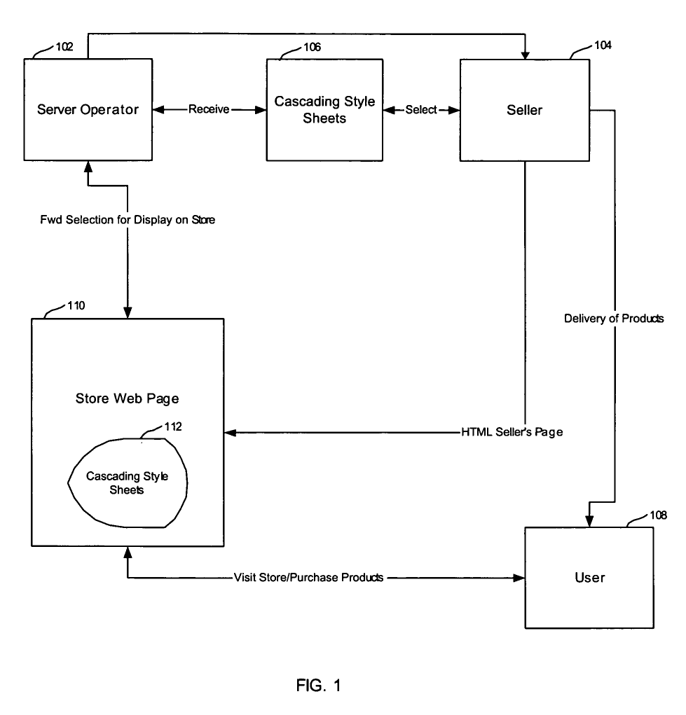

Turning first to FIG. 1, there is illustrated a simple block diagram of the system envisioned by the present invention. One of ordinary skill in the art will appreciate that the implementation of the present invention is accomplished via computer network or networks. The diagram provides the four basic entities used in the envisioned system. These include the Server Operator 102, the Seller 104, the Cascading Style Sheet(s) 106, the User 108, the Store Web Page, and the Display 112 of the Cascading Style Sheets 106. These will be explained in detail below. The system, as one of ordinary skill will appreciate, further comprises a computer network providing communications between remote devices, various communications protocols, servers, clients, and the like. The person of ordinary skill will appreciate that the present invention, while implemented here over the Internet, need not be so limited. For example, any computer system, such as a computer system in a large store, mall or the like, suitably uses the system and method envisioned herein.

The Server Operator 102 comprises a company or individual that owns or operates the server(s) that controls and contains the Cascading Style Sheet(s) 106, templates, forms, and data as well as hosts the Store Web Page 110. Typically, the Server Operator 102 functions over a server (not shown) connected to the Internet. Communicatively coupled to the Server Operator 102 over the Internet is the Seller 104. The Seller 104 represents the company or individual using the services of the Service Operator 102 to show/sell the Seller's 104 products online. Via the Internet connection, the Seller 104 selects the appropriate Cascading Style Sheet 106 for Display 112 on the Store Web Page 110.

The Cascading Style Sheets 106 are stored in different formats on the Server Operator's 102 server. The term Cascading Style Sheets is a simple styling language which allows attaching style to HTML elements. Every element type as well as every occurrence of a specific element within that type is suitably declared a unique style, e.g. margins, positioning, color or size. Style Sheets are templates, very similar to templates in desktop publishing applications, containing a collection of rules declared to various selectors (elements). Cascading Style Sheets provides users with the ability to separate the appearance of a web page from the content of that web page. While a Cascading Style Sheet is used in this embodiment, one of ordinary skill in the art will appreciate that other methods of dynamic web page design are available and may be substituted for use herein.

Every Cascading Style Sheet is a text file, or text embedded in the head of an HTML document, enabling the separation of appearance from content. The Cascading Style Sheet is a set of instructions which suggest to a web browser how the corresponding page or pages should be displayed. Information regarding a web page is broken into content and appearance. The appearance takes the form of a Cascading Style Sheet document (.css file or embedded in the head element of an HTML document) and the content takes the form of an HTML document with a link to the Cascading Style Sheet file. The appearance and content are transmitted to a user's agent, e.g., web browser, and displayed to the user.

Every Cascading Style Sheet, whether or not it is a separate .css file or embedded, is a series of instructions called statements. Statements identify elements in an HTML document affected by the Cascading Style Sheet and also instruct the web browser how to generate the HTML elements. An element is capable of being a paragraph, sentence, link, list item, and the like. The HTML side sees elements as anything marked up inside the HTML tags. That part of the statement which identifies the page elements is termed a selector, i.e., the selector selects page elements. That part of the statement which tells a web browser how selected elements should be drawn is referred to as the declaration. A declaration may contain any number of properties. Properties are the individual pieces of styles to be applied to the particularly element.

Returning to FIG. 1, the Cascading Style Sheets 106 of the present invention incorporate the customizations, modifications, deletions or creations the Seller 104 directs the Server Operator 102 to incorporate in the Store Web Page 110. The Store Web Page 110 exists on a server remote from the Seller 104, but operated by the Service Operator 102. The Store Web Page 110 offers multiple sellers the ability to increase their product distribution. Communicatively coupled to the Web Page 110 is the Cascading Style Sheets Display 112. The Display 112 comprises a separate web page, linked off the Web Page 110 that incorporates the Cascading Style Sheets 106 selected or created by Seller 104. The User 108 connects to the Internet and enters the Store Web Page 110. There, the User 104 clicks the hyperlink to the Cascading Style Sheets Display 112 containing the Cascading Style Sheets 106 and the Seller's 104 own HTML information. The User 108 places an order for a product featured therein and awaits delivery of the product from the Seller 104.

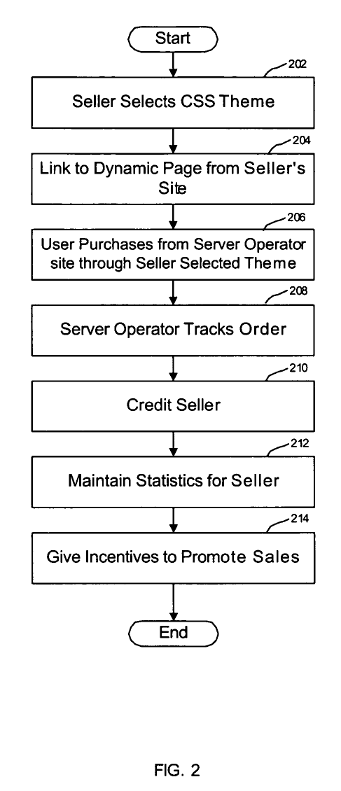

The functioning of the system depicted in FIG. 1 may more readily be explained by turning now to FIG. 2, which illustrates a flow chart demonstrating the operation of the envisioned invention. Beginning at step 202, the Seller 104 selects an appropriate Cascading Style Sheet 106 from an available database of choices. The Seller 104 may utilize one of the templates stored therein, or may endeavor to create a new Cascading Style Sheet 106. In either instance, the theme selected by the Seller 104 in the form of a Cascading Style Sheet 106 is forwarded to the Server Operator 102 for incorporation into the Store Web Page 110.

Having selected the theme Cascading Style Sheet 106 in step 202, the Seller 104 then proceeds to step 204 wherein the Seller 104 links to this new dynamic page from Seller's 104 existing website. The HTML code is not stored by the Server Operator 102 on the Store Web Page 110, but rather the HTML links are combined with the theme Cascading Style Sheet 106 into Display 112. The Server Operator 102 is then able to modify, add or delete content from the Store Web Page 110 without requiring the interaction of the Seller 104. That is, the Server Operator 102 may edit the theme Cascading Style Sheet 106 without Seller 104 involvement. The Seller 104 still hosts its own website, selling or marketing only its products, and concurrently the same products are made available for sale via the Store Web Page 110.

After the creation of the theme Cascading Style Sheet 106 in step 202 and the linking of the new dynamic web page in step 204, the system proceeds to involve the User 108 in the process. The User 108 visits the Store Web Page 110 via any suitable means to purchase the goods or services sold thereon. As the User 108 browses through the Store Web Page 110, the User 108 happens upon the goods or services sold by Seller 104 on the theme Cascading Style Sheet 106 shown on the Cascading Style Sheets Display 112 page of the Web Page 110. At step 206, the User 108 then purchases from the Store Web Page 110 through the theme Cascading Style Sheet Display 110. The User 108 accomplishes this purchase by clicking on the displayed products or services desired, which links the theme Cascading Style Sheet Display 110 to the Seller's 104 website.

At step 208, the Server Operator 102, through the Store Web Page 110 tracks the order status. After tracking, the Server Operator 102 then credits the Seller 104 at step 210 for the sale and maintains statistical analyses of the purchases made at step 212. In order to increase the effectiveness of the envisioned system and method, step 214 provides incentives for the Seller 104 to promote sales over the Server Operator 102 Store Web Page 110.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications.

Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of the ordinary skilled in the art to utilize the invention in various embodiments and with various modifications as are suited to the particular use contemplated. All such modifications and variations are within the scope of the invention as determined by the appended claims when interpreted in accordance to the breadth to which they are fairly, legally and equitably entitled.

What is claimed is:

1. A system for facilitating network-based commerce comprising:
template means adapted to generate electronic document data representative of plurality of preselected document display templates;
means adapted for communicating selection data associated with the electronic document data to an associated operator;
means adapted for receiving from the associated operator customization data, which customization data includes data representative of at least one of selected margins, positioning, color, and size, and wherein the customization data includes at least one of product data and service data, wherein the product data is representative of products available for sale and wherein the service data is representative of available services for sale;
means adapted for generating, from the electronic document data and the customization data, customized electronic document data representative of a customized user interface;
server means adapted for storing the customized electronic document data;
means adapted for communicating the customized electronic document data to an associated customer in accordance with a received customer query; and
means adapted for receiving, from the associated customer, data representative of at least one of the products and the services.

2. The system for facilitating network-based commerce of claim 1, further comprising:
means adapted for storing site data representative of a selected network accessible user interface; and
means adapted for receiving the customized electronic document data.

3. The system for facilitating network-based commerce of claim 2, further comprising:
means adapted for receiving secondary customization data from a secondary operator; and
means adapted for modifying the customized electronic document data in accordance with the secondary customization data.

4. A method for facilitating network-based commerce, comprising the steps of:
generating electronic document data representative of plurality of preselected document display templates;
communicating selection data associated with the electronic document data to an associated operator;
receiving from the associated operator customization data, which customization data includes data representative of at least one of selected margins, positioning, color, and size, and wherein the customization data includes at least one of product data and service data, wherein the product data is representative of products available for sale and wherein the service data is representative of available services for sale;
generating, from the electronic document data and the customization data, customized electronic document data representative of a customized user interface;
storing the customized electronic document data on a server;
communicating the customized electronic document data to an associated customer in accordance with a received customer query; and
receiving, from the associated customer, data representative of at least one of the products and the services.

5. The method for facilitating network-based commerce of claim 4, further comprising the steps of:
storing site data representative of a selected network accessible user interface; and
receiving the customized electronic document data.

6. The method for facilitating network-based commerce of claim 5, further comprising the steps of:
receiving secondary customization data from a secondary operator; and
modifying the customized electronic document data in accordance with the secondary customization data.

7. A computer-readable medium of instructions with computer-readable instructions stored thereon for facilitating network-based commerce, comprising:
instructions for generating electronic document data representative of plurality of preselected document display templates;
instructions for communicating selection data associated with the electronic document data to an associated operator;
instructions for receiving from the associated operator customization data, which customization data includes data representative of at least one of selected margins, positioning, color, and size, and wherein the customization data includes at least one of product data and service data, wherein the product data is representative of products available for sale and wherein the service data is representative of available services for sale;
instructions for generating, from the electronic document data and the customization data, customized electronic document data representative of a customized user interface;
instructions for storing the customized electronic document data on a server;
instructions for communicating the customized electronic document data to an associated customer in accordance with a received customer query; and
instructions for receiving, from the associated customer, data representative of at least one of the products and the services.

8. The computer-readable medium of instructions with computer-readable instructions stored thereon for facilitating network-based commerce of claim 7, further comprising:
instructions for storing site data representative of a selected network accessible user interface; and
instructions for receiving the customized electronic document data.

9. The computer-readable medium of instructions with computer-readable instructions stored thereon for facilitating network-based commerce of claim 8, further comprising:
instructions for receiving secondary customization data from a secondary operator; and
instructions for modifying the customized electronic document data in accordance with the secondary customization data.

10. A computer-implemented method for facilitating network-based commerce, comprising the steps of:
generating electronic document data representative of plurality of preselected document display templates;
communicating selection data associated with the electronic document data to an associated operator;
receiving from the associated operator customization data, which customization data includes data representative of at least one of selected margins, positioning, color, and size, and wherein the customization data includes at least one of product data and service data, wherein the product data is representative of products available for sale and wherein the service data is representative of available services for sale;
generating, from the electronic document data and the customization data, customized electronic document data representative of a customized user interface;
storing the customized electronic document data on a server;
communicating the customized electronic document data to an associated customer in accordance with a received customer query; and
receiving, from the associated customer, data representative of at least one of the products and the services.

11. The computer-implemented method for facilitating network-based commerce of claim 10, further comprising the steps of:
storing site data representative of a selected network accessible user interface; and
receiving the customized electronic document data.

12. The computer-implemented system for facilitating network-based commerce of claim 11, further comprising the steps of:
receiving secondary customization data from a secondary operator; and
modifying the customized electronic document data in accordance with the secondary customization data.
